(19) United States
(12) Patent Application Publication
(10) Pub. No.: US 2017/0217250 A1
(43) Pub. Date: Aug. 3, 2017

(54) BICYCLE HUB APPARATUS

(71) Applicant: CHING-SHU CHEN, Changhua (TW)

(72) Inventor: CHING-SHU CHEN, Changhua (TW)

(73) Assignee: CHOSEN CO., LTD., CHANGHUA (TW)

(21) Appl. No.: 15/014,310

(22) Filed: Feb. 3, 2016

(51) Int. Cl. B60B 27/04; F16D 41/32; B60B 27/02

(52) U.S. Cl. CPC B60B 27/047; B60B 27/023; F16D 41/32; B60B 2900/212; B60B 2900/325; F16D 23/12

(57) ABSTRACT

A bicycle hub apparatus may include a hub body and a freewheel body, and a first driving ring, a second driving ring, and third driving ring are sequentially located between the hub body and the freewheel body. The second driving ring is coupled inside the first driving ring to rotate around a shaft of the hub body simultaneously. A second lateral surface of the second driving ring facing to the third driving ring has a plurality of first engaging teeth, and a plurality of second engaging teeth protruding from a first surface of the third driving ring which faces to the second driving ring is configured to engage with the first engaging teeth of the second driving ring. The number of the second engaging teeth is a multiple of the first engaging teeth, to improve the engagement between the first engaging teeth and the second engaging teeth.

### FIELD OF THE INVENTION

The present invention relates to a hub apparatus and more particularly to a bicycle hub apparatus.

### BACKGROUND OF THE INVENTION

Generally, referring to FIGS. 9 to 11, a bicycle hub apparatus comprises a hub body (60) and a freewheel body (61), and a blocking ring (70) is formed inside an accommodating space of the hub body (60). An inner periphery of the blocking ring (70) has a plurality of tapered slots (71) arranged in a circular pattern, and a blocking edge (72) protrudes from an inner peripheral edge of the blocking ring (70). A first driving unit (80) formed between the hub body (60) and the freewheel body (61) comprises a first driving base (81). A plurality of first driving teeth (821) protruding from an outer surface of the first driving base (81) are arranged in a circular pattern. A second driving unit (90) located inside the blocking ring (70) can achieve axially linear movement relative to the tapered slots (71), and the second driving unit (90) is located a position corresponding to the first driving unit (80). A second driving base (91) formed on a surface of the second driving unit (90) comprises a plurality of protruding pieces (92) which are arranged along an outer periphery of the second driving base (91), and each of the protruding pieces (92) is configured to couple with each of the tapered slots (71) respectively. Also, a blocking portion (93), which is formed at a first outer peripheral edge of the second driving unit (90) closing to the blocking ring (70), is configured to bear against an inner surface of the blocking edge (72) to limit the position of the second driving unit (90). The second driving unit (90) further comprises a second teeth base (94) facing to the first driving unit (80) and having a position corresponding to the first driving base (81). A plurality of second driving teeth (941) protruding from an outer surface of the second teeth base (94) are arranged in a circular pattern to engage with the first driving teeth (821).

However, the conventional bicycle hub apparatus is disadvantageous because: (i) the separated distances between each two teeth (821) and the number of the first driving teeth (821) on the first teeth base (82) of the first driving unit (80) are designed corresponding to the second driving teeth (941) on the second teeth base (94) of the second driving unit (90). With initial driving teeth number, the first driving teeth (821) and the second driving teeth (941) must be able to engage with each other and run normally. However, when the teeth ratios of the driving teeth (821)(941) need to be increased to achieve a rapid acceleration of the bicycle, the working depths of the driving teeth (821)(941) must be shallower. Thus, it might lead that the two driving teeth (821)(941) cannot firmly engage with each other, and the engagement between the first driving base (82) and the second driving base (94) becomes unreliable, resulting in increasing the damage of driving teeth and lowering the life time of the hub apparatus. Therefore, there remains a need for a new and improved design for a bicycle hub apparatus to overcome the problems presented above.

### SUMMARY OF THE INVENTION

The present invention provides a bicycle hub apparatus, which comprises a hub body and a freewheel body, and a first driving ring, a second driving ring, and third driving ring mounted on a shaft of the hub body are sequentially located between the hub body and the freewheel body. The first driving ring connected with an elastic unit is mounted into an inner space of the hub body, and a plurality of first driving teeth are formed at an inner periphery of the first driving ring. The second driving ring is coupled inside the first driving ring, and a plurality of second driving teeth formed at an outer periphery of the second driving ring are configured to be mated with the first driving teeth. The freewheel body comprises a non-circular opening which is configured to receive the third driving ring, and thus the freewheel body and the third driving ring can be rotated simultaneously. A plurality of second engaging teeth protruding from a first surface of the third driving ring which faces to the second driving ring is configured to engage with the first engaging teeth of the second driving ring. Moreover, separated distances between each two adjacent second engaging teeth are wider than each two adjacent first engaging teeth, and each of second planes formed between each two adjacent second engaging teeth is designed in the same dimension. Furthermore, the number of the second engaging teeth is a multiple of the first engaging teeth, thus enhancing the smoothness and firmness of engagement between the first engaging teeth and the second engaging teeth.

Comparing with conventional bicycle hub apparatus, the present invention is advantageous because: the separated distances between each two adjacent second engaging teeth are wider than each two adjacent first engaging teeth, and the number of the first engaging teeth is a multiple of the second engaging teeth. When the teeth ratio of the first engaging teeth is increased to achieve a rapid acceleration for a bicycle, the second planes formed between each two adjacent second engaging teeth can enhance working depths between the two engaging teeth, further improving the smoothness and firmness of engagement between the first engaging teeth and the second engaging teeth.

### BRIEF DESCRIPTION OF THE DRAWINGS

FIG. 1 is a three-dimensional view of a bicycle hub apparatus in the present invention.

FIG. 2 is an exploded view of the bicycle hub apparatus in the present invention.

FIG. 3 is a sectional view of the bicycle hub apparatus in the present invention.

FIG. 4 is a schematic view of the bicycle hub apparatus in present invention when a second driving ring is engaged with a third driving ring to be rotated simultaneously.

FIG. 5 is a partial enlarged schematic view of the bicycle hub apparatus in present invention when the second driving ring is engaged with the third driving ring to be rotated simultaneously.

FIG. 6 is a schematic view of the bicycle hub apparatus in the present invention when the second driving ring is disengaged with the third driving ring.

FIG. 7 is a partial enlarged schematic view of the bicycle hub apparatus in present invention when the second driving ring is disengaged with the third driving ring.

FIG. 8 is a three-dimensional view of another embodiment of the bicycle hub apparatus in the present invention.

FIG. 9 is a prior art.

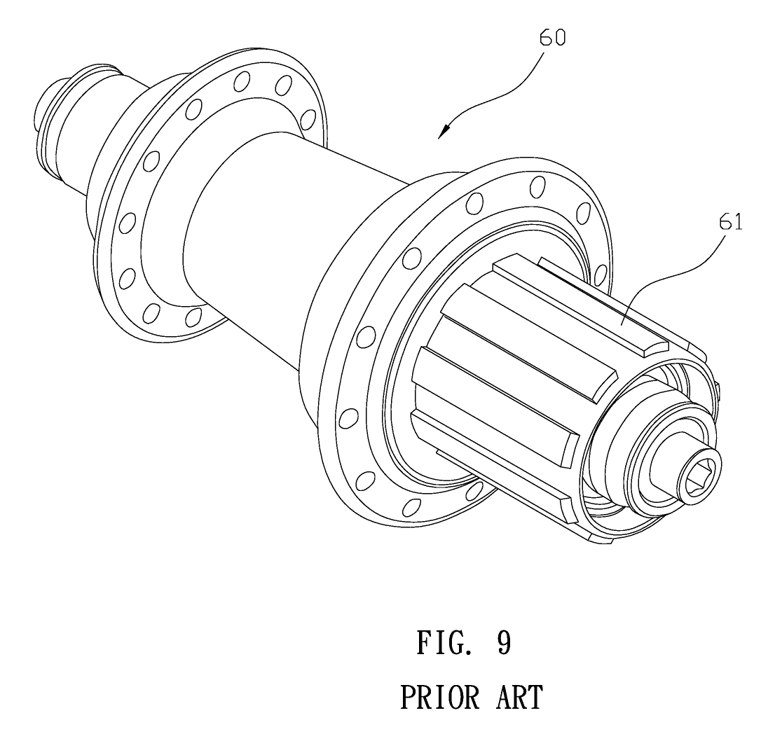

FIG. 10 is a prior art.

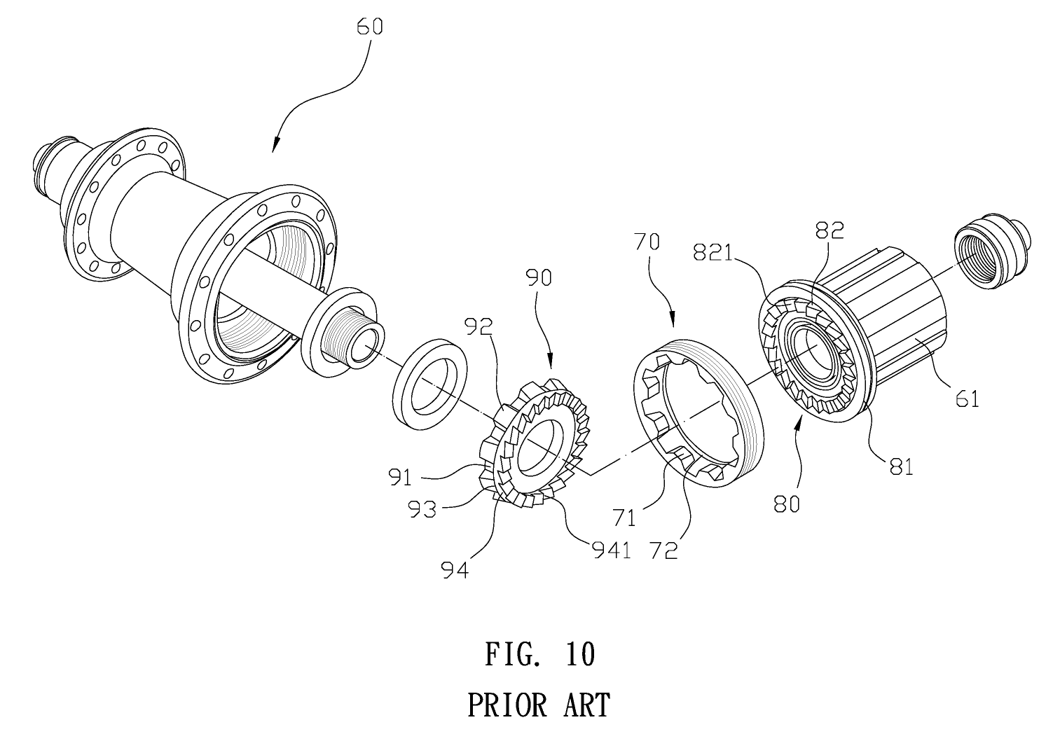

FIG. 11 is a prior art.

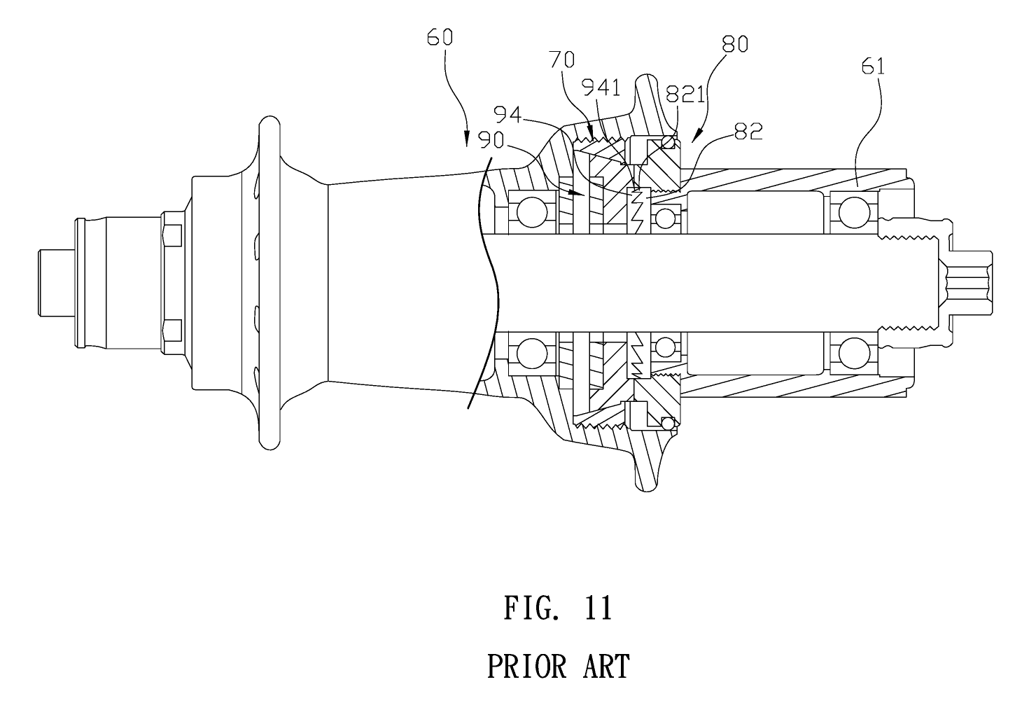

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

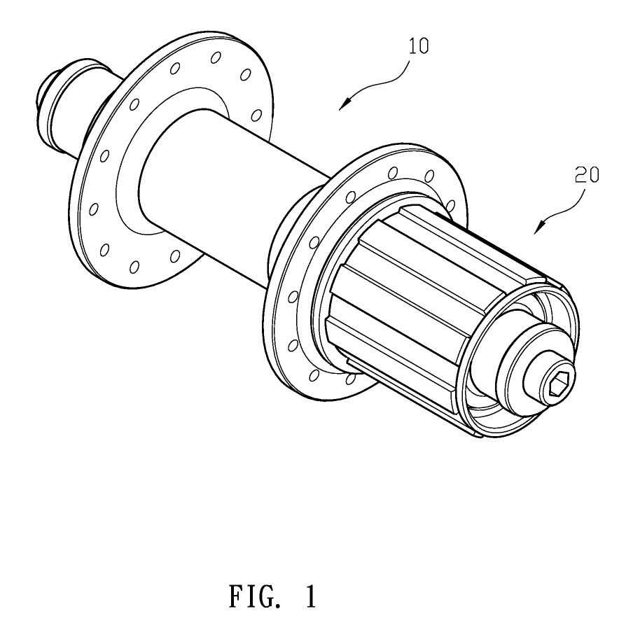

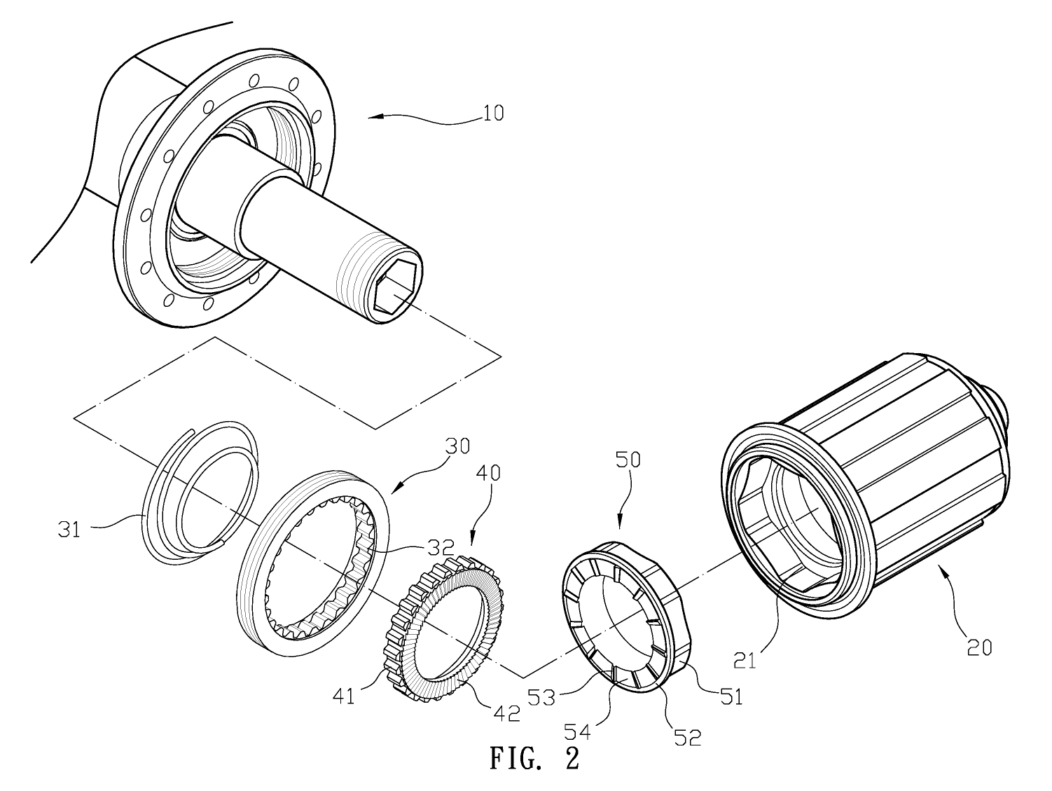

Referring to FIGS. 1 and 2, the present invention provides a bicycle hub apparatus, which comprises a hub body (10) and a freewheel body (20), and a first driving ring (30), a second driving ring (40), and third driving ring (50) mounted on a shaft of the hub body (10) are sequentially located between the hub body (10) and the freewheel body (20). The first driving ring (30) connected with an elastic unit (31) is mounted into an inner space of the hub body (10), and a plurality of first driving teeth (32) are formed at an inner periphery of the first driving ring (30). The second driving ring (40) is coupled inside the first driving ring (30), and a plurality of second driving teeth (41) formed at an outer periphery of the second driving ring (40) are configured to be mated with the first driving teeth (32). Also, after the second driving ring (40) is connected to the first driving ring (30), the elastic unit (31) is borne against a first lateral surface of the second driving ring (40) which faces to the hub body (10) to provide an elastic force pushing the second driving ring (40) outwardly. A second lateral surface of the second driving ring (40) facing to the third driving ring (50) has a plurality of first engaging teeth (42). The freewheel body (20) comprises a non-circular opening (21) which is configured to receive the third driving ring (50), and thus the freewheel body (20) and the third driving ring (50) can be rotated simultaneously. A non-circular engaging surface (51) formed around an outer periphery of the third driving ring (50) is configured to engage with the opening (21). A first edge of the outer periphery of the third driving ring (50), which closes to the second driving ring (40), comprises a blocking edge (52) which is configured to bear against an upper edge of the opening (21) to limit a position of the third driving ring (50), and a plurality of second engaging teeth (53) protruding from a first surface of the third driving ring (50) which faces to the second driving ring (40) is configured to engage with the first engaging teeth (42) of the second driving ring (40). Moreover, the separated distances between each two adjacent second engaging teeth (53) are wider than each two adjacent first engaging teeth (42), and each of second planes (54) is formed between each two adjacent second engaging teeth (53). Furthermore, the number of the second engaging teeth (53) is a multiple of the first engaging teeth (42), and an optimized number of the second engaging teeth (53) is five to ten times more than the first engaging teeth (42).

Structurally, referring to FIGS. 1 to 3, the hub body (10) has the inner space to sequentially receive the elastic unit (31) and the first driving ring (30), and an outer periphery of the first driving ring (30) has a first threaded portion to engage with a second threaded portion formed at an inner periphery of the inner space. Thus, the elastic unit (31) is located between the hub body (10) and the first driving ring (30). The second driving ring (40) is coupled with the inner periphery of the first driving ring (30), and the first engaging teeth (42) protrudes from the first lateral surface of the second driving ring (40) which faces to the third driving ring (50). The second driving teeth (41) formed at the outer periphery of the second driving ring (40) are engaged with the first driving teeth (32) to allow the first driving ring (30) and the second driving ring (40) to be rotated simultaneously. Because of the resilience of the elastic unit (31), the second driving ring (40) borne by the elastic unit (31) can axially move forward and backward inside the inner space of the hub body (10). The third driving ring (50) is mounted into the opening (21) of the freewheel body (20) through the engaging surface (51), and the blocking edge (52) is borne against the upper edge of the opening (21). Then, the third driving ring (50) is secured inside the freewheel body (20) to be rotated simultaneously. Furthermore, when the freewheel body (20) is connected to the hub body (10), the second driving ring (40) pushed outwardly by the elastic unit (31) is borne against the third driving ring (50). Therefore, the first engaging teeth (42) can firmly engage with the second engaging teeth (53).

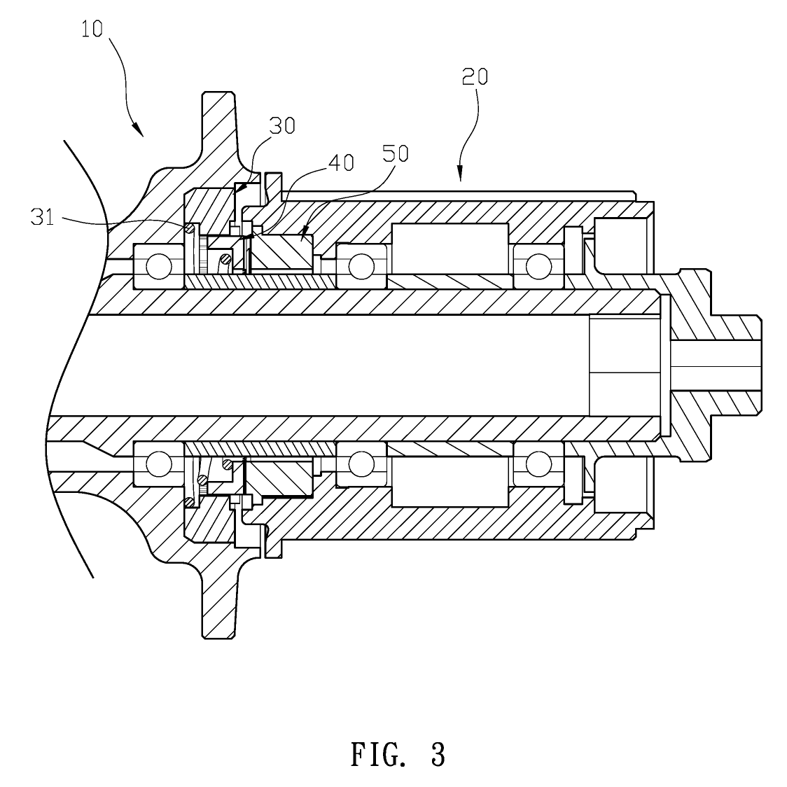

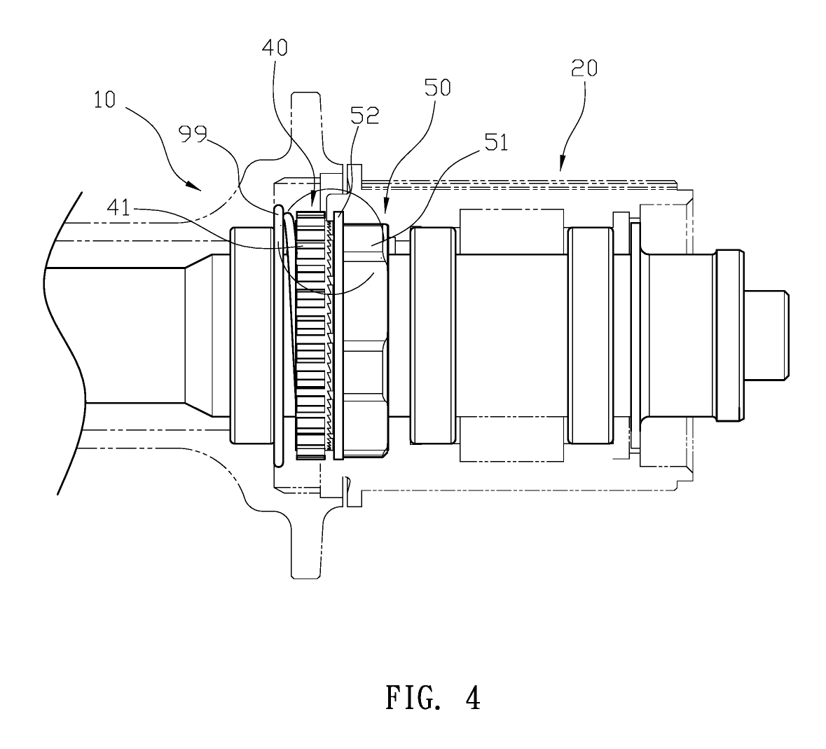

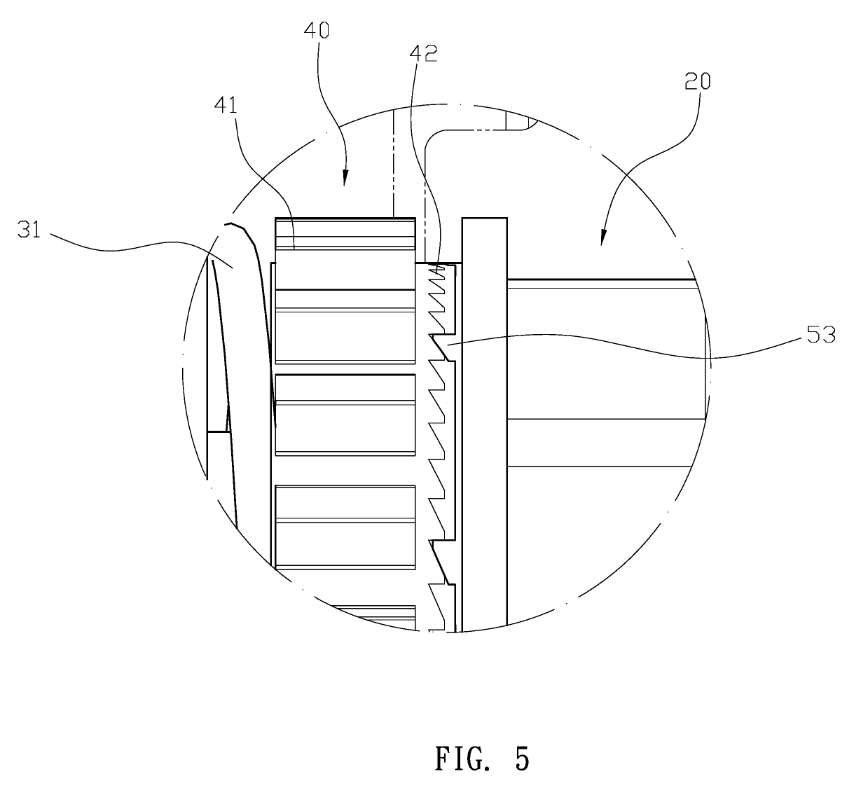

In actual application, referring to FIGS. 3 to 5, sprockets (not shown) are mounted on the hub apparatus through the freewheel body (20). When a bicyclist pedaling forward, crank arms drive the sprockets to rotate the freewheel body (20) and the third driving ring (50) simultaneously. Also, since the second engaging teeth (53) of the third driving ring (50) are engaged with the first engaging teeth (42) of the second driving ring (40), the second driving ring (40) driven by the third driving ring (50) can rotate the first driving ring (30) and the hub body (10) simultaneously. Thus, the bicycle is moved forwardly.

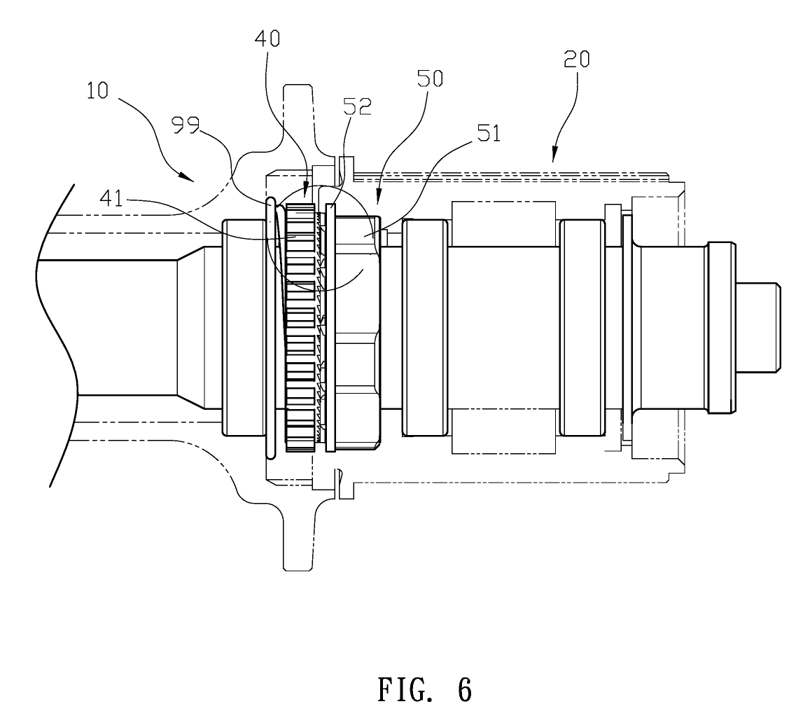

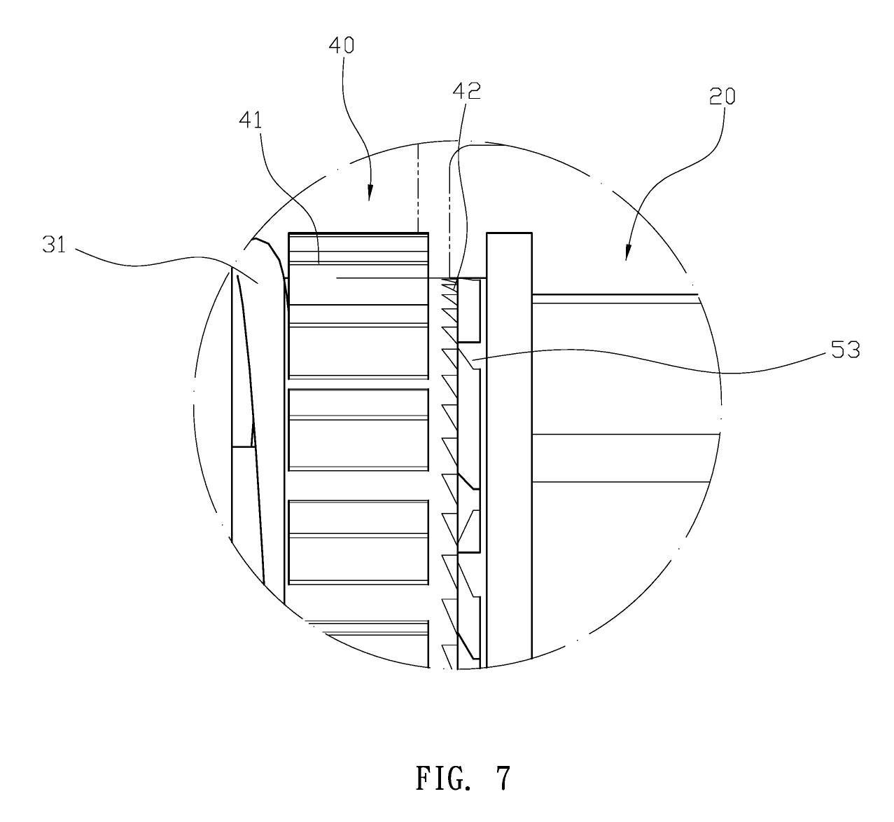

On the other hand, when the bicyclist pedaling in a reverse direction, referring to FIGS. 6 and 7, the second engaging teeth (53) are disengaged with the first engaging teeth (42), and the third driving ring (50) is pushed by the second driving ring (40) to move toward the inner space of the hub body (10). Thus, the hub body (10) is disengaged with the freewheel body (20), and each of the hub body (10) and the freewheel body (20) rotates around the shaft independently. When the bicyclist stops pedaling during the bicycle moving forward, the first engaging teeth (42), likewise, are disengaged with the second engaging teeth (43), and the bicycle keeps coasting when the hub body (10) rotating independently.

As a structure of the bicycle hub apparatus mentioned above, the separated distances between each two adjacent second engaging teeth (53) are wider than each two adjacent first engaging teeth (42), and the number of the first engaging teeth (42) is a multiple of the second engaging teeth (53). When the teeth ratio of the first engaging teeth (42) is increased to achieve a rapid acceleration for a bicycle, the second planes (43) formed between each two adjacent second engaging teeth (53) can enhance working depths between the engaging teeth (42)(53), further enhancing the smoothness and firmness of engagement between the first engaging teeth (53) and the second engaging teeth (42).

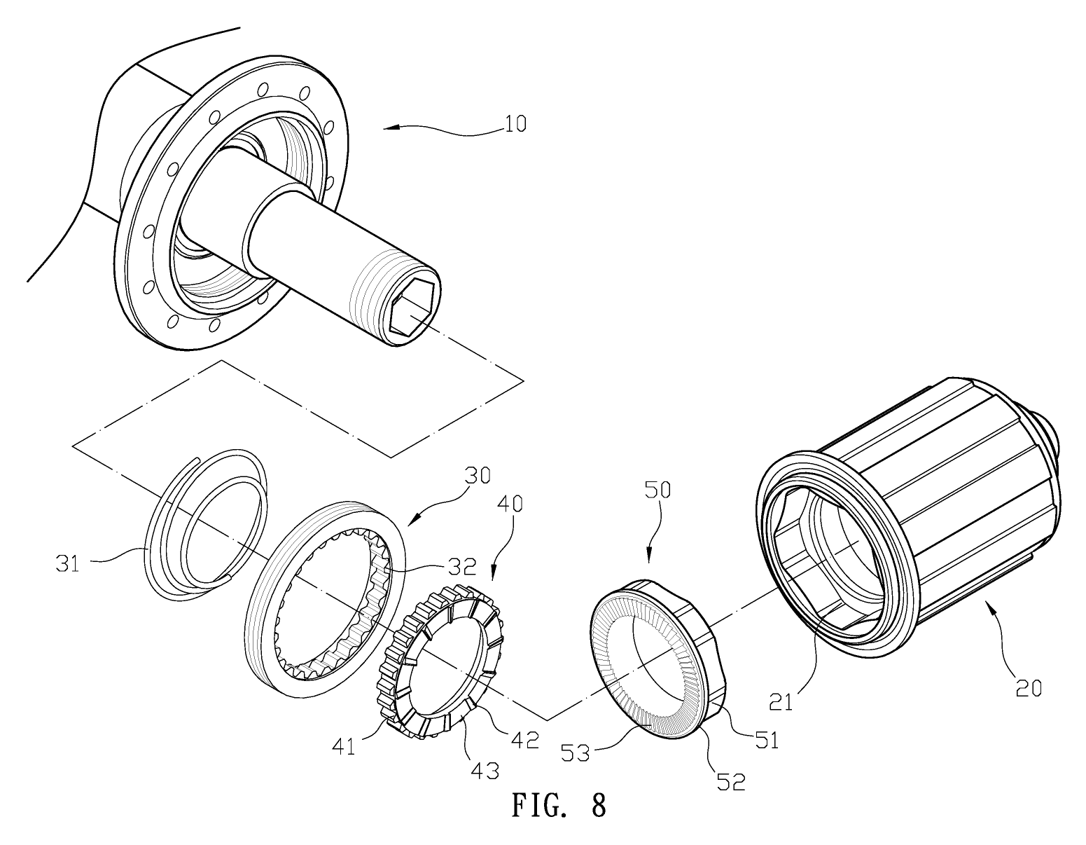

In another embodiment, referring to FIG. 8, the first engaging teeth (42) of the second driving ring (40) can switch the position with the second engaging teeth (53), and the separated distances between each two adjacent first engaging teeth (42) are wider than each two adjacent second engaging teeth (53). Also, each of the first planes (43) formed between each two adjacent first engaging teeth (42) is designed in the same dimension, and the number of the second engaging teeth (42) is a multiple of the first engaging teeth (53) to enhance the firmness of engagement between the engaging teeth (42)(53).

What is claimed is:

1. A bicycle hub apparatus comprising a hub body and a freewheel body, and a first driving ring, a second driving ring, and third driving ring mounted on a shaft of the hub body which are sequentially located between the hub body and the freewheel body, wherein the first driving ring connected with an elastic unit is mounted into an inner space of the hub body, and a plurality of first driving teeth are formed at an inner periphery of the first driving ring, wherein the second driving ring is coupled inside the first driving ring, and a plurality of second driving teeth formed at an outer periphery of the second driving ring are configured to be mated with the first driving teeth, wherein the third driving ring is mounted into the freewheel body to be rotated simultaneously, wherein a plurality of second engaging teeth protruding from a first surface of the third driving ring which faces to the second driving ring is configured to engage with the first engaging teeth of the second driving ring, and separated distances between each two adjacent second engaging teeth are wider than each two adjacent first engaging teeth, and each of second planes formed between each two adjacent second engaging teeth is designed in the same dimension, wherein the number of the second engaging teeth is a multiple of the first engaging teeth, thus enhancing the smoothness and firmness of engagement between the first engaging teeth and the second engaging teeth.

2. The bicycle hub apparatus of claim 1, wherein, in one embodiment, the first engaging teeth of the second driving ring is configured to switch the position with the second engaging teeth, and the separated distances between each two adjacent first engaging teeth are wider than each two adjacent second engaging teeth, and each of the first planes formed between each two adjacent first engaging teeth are in the same dimension, and the number of the second engaging teeth is a multiple of the first engaging teeth to enhance the firmness of engagement between the engaging teeth.

3. The bicycle hub apparatus of claim 1, wherein the second driving ring is mounted inside of the first driving ring, and the elastic unit is borne against a first lateral surface of the second driving ring which faces to the first driving ring, wherein the resilience of the elastic unit provides a retractable space for the second driving ring to be compressed toward the hub body.

4. The bicycle hub apparatus of claim 1, wherein the freewheel body has a non-circular opening which is configured to receive the third driving ring, and a non-circular engaging surface formed around an outer periphery of the third driving ring is engaged with the opening of the freewheel body, and thus the freewheel body and the third driving are able to be rotated around the shaft simultaneously.

5. The bicycle hub apparatus of claim 4, wherein a first edge of the outer periphery of the third driving ring, which closes to the second driving ring, comprises a blocking edge which is configured to bear against an upper edge of the opening to limit a position of the third driving ring, and a plurality of the second engaging teeth protrude from a first surface of the blocking edge which faces to the second driving ring.

6. The bicycle hub apparatus of claim 1, wherein an optimized teeth ratio between the first engaging teeth and the second engaging teeth is from five to ten.
